(19) United States
(12) Patent Application Publication
(10) Pub. No.: US 2004/0166234 A1
(43) Pub. Date: Aug. 26, 2004

(54) Apparatus and method for coating a light source to provide a modified output spectrum

(76) Inventors: Bee Yin Janet Chua, Penang (MY); Boon Chun Tan, Penang (MY); Chan Meng Leong, Penang (MY)

Correspondence Address: AGILENT TECHNOLOGIES, INC., Legal Department, DL429, Intellectual Property Administration, P. O. Box 7599, Loveland, CO, 80537-0599, US

(21) Appl. No.: 10/375,321

(22) Filed: Feb. 26, 2003

(51) Int. Cl. B05D 5/06; B05D 1/18; B05D 5/10

(52) U.S. Cl. 427/64; 427/207.1; 427/430.1; 427/421.1; 427/157; 118/620

(57) ABSTRACT

The present invention provides a method and apparatus for coating a light source to provide a modified output spectrum. Liquid adhesive is applied to the light source to form an adhesive layer. Luminescent material is fluidized and at least a portion of the adhesive layer immersed in the fluidized luminescent material to form a coated light source. The luminescent material can be a mixture of a phosphor compound and a fluidization enhancement substance, such as fumed silica.

### FIELD OF THE INVENTION

In general, the invention relates to light emission sources. More specifically, the invention relates to a method and apparatus for coating a light source to provide a modified output spectrum.

### BACKGROUND OF THE INVENTION

Light emitting diodes (LEDs) are increasingly used as a light source for lighting applications. Recently, it has become possible to generate white light from LEDs because of the advent of LEDs that utilize gallium nitride (GaN)based or indium gallium nitride (InGaN)-based epitaxial structures to generate light in the ultraviolet (UV) to blue portion of the spectrum.

A type of LED increasingly utilized in lighting applications is a white LED device. The white LED device, as the name implies, emits light that appears white to an observer. In one example, this is achieved by combining an LED that emits blue light (a “blue LED”) and a phosphor such as cerium activated yttrium aluminum garnet (Y₃Al₅O₁₂:Ce³⁺). The blue LED emits a first light typically with peak wavelength of 460 to 480 nanometer (nm) as an excitation light. The phosphor partially absorbs the blue light and emits a second broadband light with peak wavelength of 560 to 580 nm, generally in the yellow light portion of the spectrum. The combination of the second light with the unabsorbed first light is perceived as white light by the observer. The quality of white light produced is dependent on the balancing of the blue light with the yellow light emission from the phosphor material.

FIG. 1 details a typical design of a through-hole package assembly 100 presently utilized within the industry. The through-hole package assembly 100 of FIG. I utilizes a pre-dip methodology to produce the through-hole package assembly 100. In this example of utilizing pre-dip methodology to produce the through-hole package assembly, a blue LED 110 is placed inside a receptacle 120, which forms one part of electrical element 130. A bond wire 140 is made between LED 110 and electrical conductor 150. The phosphor layer 160 is formed surrounding LED 110. The package assembly 100 is encapsulated within a transparent epoxy 170 that provides protection. As an example, Nichia Chemical Industries produces such a lamp.

Another method for producing a white LED device uses surface mount technology (SMT). FIGS. 2A and 2B illustrate the SMT process using a pre-dip and a pre-mix method respectively.

The pre-dip process, illustrated in FIG. 2A, includes placing an LED chip 210 onto a surface of reflector cup 230, where it is connected using wire 240 to a metal contact base 220. Phosphor material layer 270 includes a phosphor and a liquid epoxy mixture and is applied to fill reflector cup 230 to cover the LED chip 210. Epoxy is then molded over phosphor material layer 270 to form an epoxy optical dome 260.

The pre-dip method permits more efficient light output from the LED device when compared to pre-mix methodology. However, the pre-dip methodology is inconsistent and difficult to control. When producing a white light output, the quality of white light production depends on balancing the blue light emission and the phosphor converted light emission. The amount of light converted by the phosphor is determined by the thickness and consistency of the phosphor layer.

Pre-dip methodology has poor consistency because it is difficult to control the thickness and uniformity of the phosphor material layer. Phosphor powder has a specific gravity greater than the specific gravity of the liquid epoxy, so that the phosphor powder sinks toward the bottom of the epoxy layer during the curing process. Therefore, the concentration of phosphor powder in the liquid epoxy compound changes over time due to the specific gravity differential and the concentration of the phosphor powder in the phosphor material layer becomes non-uniform as a result.

Additionally, the viscosity of the liquid epoxy within the phosphor material layer rises over time in the production area. Thus, the conventional technique of dispensing the phosphor material layer using pressure yields different amounts of dispensed material. Furthermore, liquid epoxy shrinks during the curing process. This reduction takes place due to solidification and evaporation of the liquid epoxy throughout the curing process.

Pre-mix methodology illustrated in FIG. 2B, can also be utilized for SMT applications. However, pre-mix methodology is not suitable for through-hole lamp applications. In pre-mix methodology, LED 210 is over-molded with the phosphor material layer 275. Phosphor material layer 275 includes a phosphor and a liquid epoxy mixture. Utilizing phosphor material layer 275 in the pre-mix methodology eliminates the requirement of dispensing the phosphor and epoxy mixture within reflector cup 230.

A consistent color emission can be obtained utilizing pre-mix methodology, as the phosphor concentration and thickness are more consistent. Unlike the pre-dip method, pre-mix methodology utilizes a B-Stage mold compound. The phosphor and liquid epoxy mixture quickly hardens and thereby reduces the degree of the phosphor powder sinking effect.

However, pre-mix methodology provides an LED device with a low output and reduced efficiency. This reduction in efficiency is due to the LED having performance characteristics similar to a point light source. The LED's light intensity is inversely proportional to the distance of the phosphor material from the point source. That is, the efficiency of light conversion decreases the farther the phosphor material is located from the light source.

Another limitation of pre-mix methodology is that the concentration of phosphor powder remains the same within the mold compound. Therefore, to counter the poor efficiency of light conversion, a higher concentration of phosphor is required in pre-mix methodology. In addition to absorbing the excitation light wavelength, the phosphor powder also scatters a portion of light emitted from the LED. Therefore, increasing the concentration of phosphor powder to offset the poor efficiency of light conversion results in increased light scattering. The light scattering results in a corresponding reduction in light output in the viewing angle of the device. Therefore, light emission efficiency drops with the pre-mix method.

It would be desirable, therefore, to provide an apparatus and method that would overcome these and other disadvantages.

### SUMMARY OF THE INVENTION

One aspect of the invention provides a method for coating a light source. Liquid adhesive is applied to the light source to form an adhesive layer. Luminescent material is fluidized and at least a portion of the adhesive layer immersed in the fluidized luminescent material to form a coated light source.

Another aspect of the invention provides a method for making a lighting device. A light emitting device is provided and liquid adhesive sprayed on the light emitting device to form an adhesive layer. A mixture of a phosphor compound and fumed silica is fluidized and at least a portion of the adhesive layer immersed in the fluidized mixture of the phosphor compound and the fumed silica to form a lighting device.

Yet another aspect of the invention provides an apparatus for coating a light source comprising means for applying liquid adhesive to the light source to form an adhesive layer, and means for fluidizing luminescent material that are adapted to receive at least a portion of the adhesive layer.

The present invention provides a coating process that is consistent, easy to control, and makes efficient use of materials. The thickness and uniformity of the adhesive layer allows efficient light production with uniform color.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram illustrating a conventional through-hole package assembly;

FIG. 2A is a schematic diagram illustrating a conventional surface mount technology assembly utilizing pre-dip methodology;

FIG. 2B is a schematic diagram illustrating a conventional surface mount technology assembly utilizing pre-mix methodology;

FIGS. 3A & 3B are schematic diagrams illustrating two embodiments of a lighting device according to the present invention;

FIG. 4 is a schematic diagram illustrating a fluidizing device according to one embodiment of the present invention; and

FIG. 5 is a flow diagram depicting an exemplary method in accordance with the present invention.

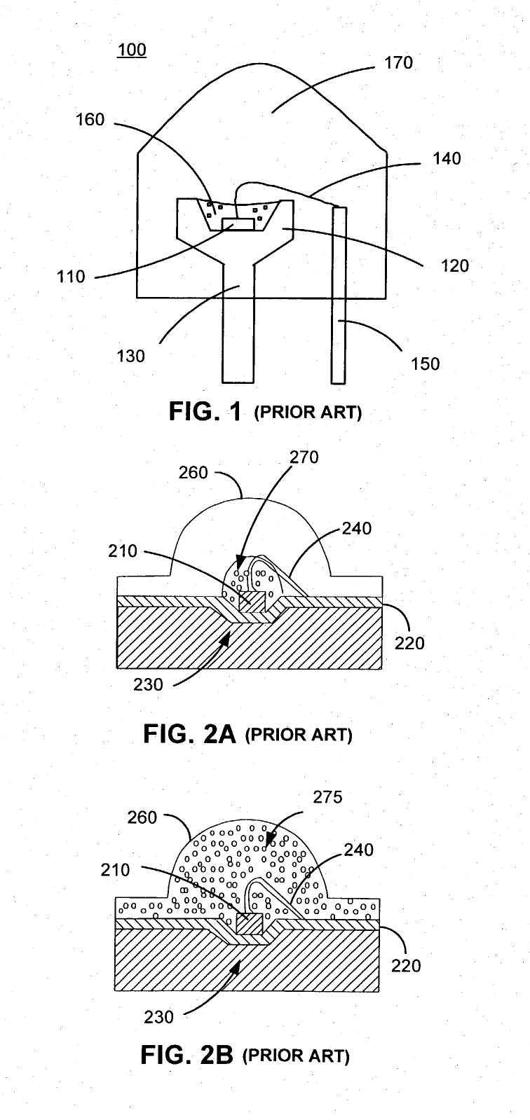

### DETAILED DESCRIPTION OF THE PRESENTLY PREFERRED EMBODIMENT

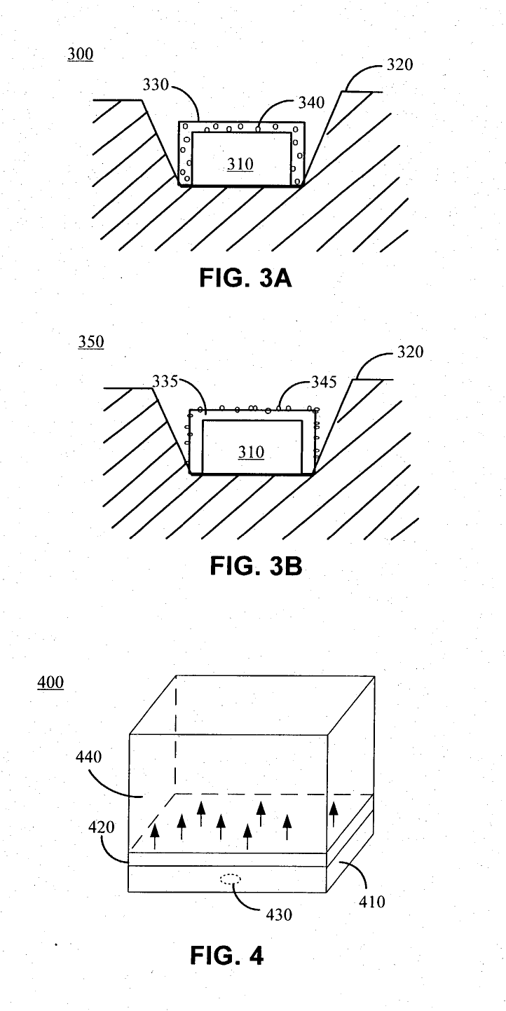

FIGS. 3A and 3B, wherein like elements share like reference numbers, are schematic diagrams illustrating two embodiments of a lighting device according to the present invention. In FIG. 3A, lighting device 300 includes a light source 310, mounting surface 320, thin adhesive layer 330, and luminescent particles 340. In FIG. 3B, lighting device 350 includes a light source 310, mounting surface 320, thin adhesive layer 335, and luminescent particles 345.

The light source 310 is coupled to mounting surface 320. In one embodiment, the lighting devices (300 and 350) are each implemented utilizing a reflector cup mounting package and each mounting surface 320 is part of the surface of the reflector cup mounting package, as shown in FIGS. 3A and 3B. In other embodiments, the lighting devices (300 and 350) are each implemented as a surface mount package (not shown) or as a through-hole package (not shown). Exemplary lighting devices are described in the U.S. patent application Ser. No. ________, filed Feb. 26, 2003, entitled Apparatus for Producing a Spectrally-Shifted Light Output from a Light Emitting Device Utilizing Thin-Film Luminescent Layers, invented by Bee Yin Janet Chua, Agilent Case No. 70011108-1, owned by the assignee of the present invention and incorporated herein by reference.

The light source 310 is a light-emitting device. In one embodiment, the light source 310 is implemented as a light-emitting diode (LED), such as a visible light-emitting diode (LED) or an ultraviolet (UV) light-emitting diode. (LED). In another embodiment, the light source 310 is a laser diode, such as a visible light laser diode or an ultraviolet (UV) laser diode. Suitable providers of LEDs and laser diodes include CREE INC. of Durham, N.C.; Epistar Corp. of Hsinchu, Taiwan; Arima Optoelectronics Corp. of Dashi Taoyuan, Taiwan; Lumileds Lighting of San Jose, Calif.; and Agilent Technologies of Palo Alto, Calif.

The thin adhesive layers (330 and 335) are each a coating formed by applying a liquid adhesive to the light source 310. The adhesive layers (330 and 335) are each applied with a specific and consistent thickness onto the exposed surface of light source 310. In one embodiment and referring to FIG. 3A, the luminescent particles 340 are deposited on the thin adhesive layer 330 and the deposited luminescent particles become disposed and embedded within the thin adhesive layer 330. In another embodiment and referring to FIG. 3B, the luminescent particles 345 are deposited on the thin adhesive layer 335. The deposited luminescent particles 345 remain disposed on and cover the thin adhesive layer 335. In one embodiment, the adhesive layer is formed from an epoxy-anhydride solution, such as PT5-42 from Pacific Polytech Inc. of Novato, Calif. In other embodiments, the adhesive layer is formed from epoxy-amine, transparent polyester, crosslinkable polyurethane, or ultraviolet (UV) curable epoxy resin.

A surfactant can be used to assure uniform coating of light source 310 with the adhesive layer 330 or the adhesive layer 335. Addition of a surfactant to the liquid adhesive reduces surface tension of the liquid adhesive allowing the liquid adhesive to form a thin adhesive layer when applied to the exposed surface of light source 310. Exemplary surfactants include Versamid® polyamide resin from the Henkel Group of Düsseldorf, Germany, and silicone surfactants such as DC193 from Dow Corning Corporation.

The luminescent particles (340 and 345) are particles of one or more luminescent materials, such as a powdered phosphor compound. Exemplary phosphor compounds, include, but are not limited to, phosphors that absorb blue light and emit yellow light, such as Y₃Al₅O₁₂:Ce³⁺; phosphors that absorb blue light and emit yellow/green light, such as YAG:Ce,Pr or (Tb₁₋ₓCeₓ)₃Al₅O₁₂:Ce³⁺ (a garnet material); phosphors that absorb blue light and emit green light, such as (Sr,Ca,Ba) (Al,Ga)₂S₄:Eu²⁺ or BaMgAl₁₀O₁₇:Eu²⁺,Mn ²⁺; phosphors that absorb blue light and emit red light, such as SrS:Eu²⁺, (Ca,Sr)S:Eu²⁺, or YVO₄:Eu³⁺,Bi³⁺; and phosphors that absorb blue light and emit blue light, such as BaMg₂Al₁₆O₂₇:Eu²⁺.

FIG. 4 is a schematic diagram illustrating a fluidizing device 400. Fluidizing device 400 includes a bottom chamber 410, fluidizing plate 420, an air entry port 430, and an upper chamber 440. The fluidizing device 400 is adapted to receive at least a portion of the adhesive layer formed by application of liquid adhesive to the light source.

Compressed gas, such as compressed air, enters bottom chamber 410 of the fluidizing device 400 via air entry port 430. The air is then forced up through apertures in the fluidizing plate 420. In one embodiment, the fluidizing plate 420 is implemented as a semi-porous plate. In other embodiments, the fluidizing plate 420 is implemented as a semi-porous polyethylene plate, as one or more layers of cloth, or as several layers of silk cloth. The compressed air then flows into the upper chamber 440. Those skilled in the art will appreciate that a gas other than air can be used in the fluidizing device 400 as desired for a particular purpose. In another embodiment, an inert gas can be used in the fluidizing device 400.

The upper chamber 440 contains powdered luminescent material, such as a mixture of phosphor compounds, and a fluidization enhancement substance, which is described in detail below. The luminescent material in upper chamber 440 is fluidized by the air flowing into the upper chamber 440 from the fluidizing plate 420. In one embodiment, upper chamber 440 is square in cross-section and orthogonal to the direction of air flow. In other embodiments, the upper chamber 440 is a cylindrical or another shape as suited to a particular application.

Fluidizing device equipment is readily available from manufacturers such as PCF of Stamford, Conn., and Advanced Powder Coatings, Inc., of Denver, Pa. Fluidizing plate equipment is readily available from manufacturers such as Porex Corporation of Fairburn, Ga.

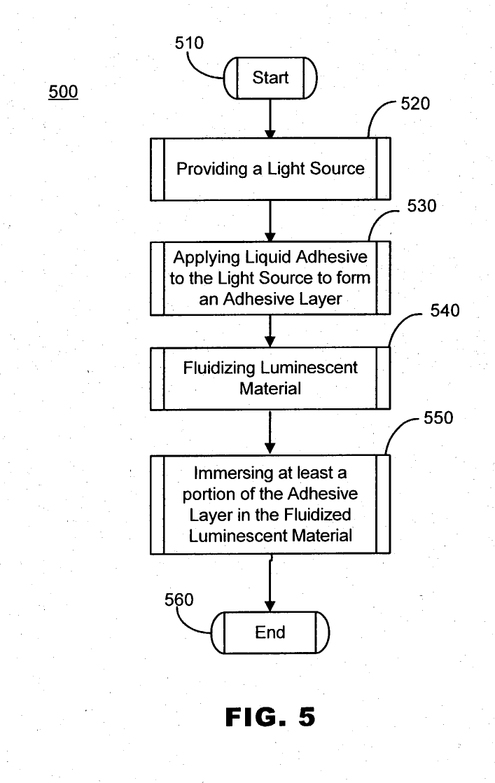

FIG. 5 is a flow diagram depicting an exemplary method in accordance with the present invention. FIG. 5 shows an embodiment of a method 500 for making a light source having a defined output spectrum. The method 500 may utilize a fluidizing device as described in FIG. 4.

The method 500 begins at block 510. At block 520, a light source is provided. At block 530, liquid adhesive is applied to the light source to form an adhesive layer. In one embodiment, the liquid adhesive is an epoxy solution. The liquid adhesive is applied to the light source by, for example, spraying, rolling, dipping, or printing. The liquid adhesive can applied to a single surface or to multiple surfaces of the light source.

In one embodiment, the liquid adhesive is printed onto the light source using an inkjet printer, such as a thermal inkjet printer or a piezoelectric inkjet printer. The liquid adhesive is placed in a reservoir, such as an inkjet printer cartridge, and then sprayed onto the light source. The inkjet printing device is controlled utilizing conventional design software, such as PowerPoint® software available from Microsoft Corporation, located in Redmond, Wash. In yet another embodiment, the spraying device can utilize continuous ink jet technology, such as EXCEL 2000™ ink jet printers from Videojet Technologies, Inc., of Wood Dale, Ill.

In other embodiments, the liquid adhesive is sprayed onto the light source utilizing a time pressure dispensing system, an industrial spraying machine, or an ink spray marking machine.

Either or both of the liquid adhesive and the light source can be heated to reduce surface tension and increase wettability. This promotes formation of a thin, uniform adhesive layer. The liquid adhesive is heated to a temperature appropriate for the particular liquid adhesive, typically 55° C.

At block 540, the luminescent material is fluidized, typically using a fluidizing device. The luminescent material is a phosphor compound, or a mixture of one or more phosphor compounds with additional materials.

In one embodiment, the luminescent material includes a fluidization enhancement substance. The fluidization enhancement substance can be a thixotropic agent, such as fumed silica. The particles of the powdered phosphor compound tend to stick to one another during the fluidizing process, thereby forming agglomerates. Fumed silica helps to break up the agglomerates.

Fumed silica has a high affinity for the phosphor compound particles, but has a much smaller particle size. Phosphor compound particles utilized in the powder coating process vary from four to nine micrometers (μm) in size, while the particle size of fumed silica is in the nanometer range. The fumed silica particles adhere to the phosphor compound particles and increase their drag during fluidization, thus preventing agglomeration. In one example, the fumed silica concentration in the powdered luminescent material is less than 15%.

Fumed silica can be produced as particles having a size of less than 20 nanometers (nm) by high temperature hydrolysis of silicon tetrachloride in an oxyhydrogen gas flame. The high temperature hydrolysis causes the fumed silica particles to stick together and form aggregate structures. The surface of the fumed silica can be specially treated for different applications. In one example, the treatment can change the fumed silica particles' affinity to water vapor present in the air. In another example, the fumed silica is heated to 105° C. for four hours to remove moisture before mixing with the phosphor compound.

One hydrophobic grade thixotropic agent is Aerosil® R972 fumed silica (CAS 60842-32-2) from Degussa AG of Düsseldorf, Germany. Aerosil® R972 has a purity of more than 99.8%, an average particle size of 16 nm, and approximately less than 0.5% moisture content. Another fumed silica is M5 manufactured by Cabbot GmbH of Hanau, Germany.

At block 550, at least a portion of the adhesive layer is immersed in fluidized luminescent material. In one embodiment, the adhesive layer is dried before immersion, although the adhesive layer can be wet, partially dry, or dry.

Additional processing can be carried out depending on the particular materials in use and the results desired. The coated light source can be cured to harden the adhesive layer. The curing process can use a conventional heat cure system, an ultraviolet (UV) curing system, or a microwave curing system. For certain adhesive layer materials, the UV curing system may be faster than a conventional heat cure system.

In one embodiment, the coated light source is inspected to verify light output of the light source. An in situ check of color and light output provides quality control, assuring that the coating has reached the desired thickness before full encapsulation of the light source. Light sources failing the inspection can be returned for further processing.

The method 500 ends at block 550. In one embodiment, the steps of applying the liquid adhesive to form an adhesive layer 530 and immersing at least a portion of the adhesive layer in fluidized luminescent material 550 can be repeated until the desired coating thickness and desired number of luminescent particles is achieved.

The method described in FIG. 5 is not limited to making a single light source, but can be used to make an array of light sources at one time. The light source or light sources can be disposed on a larger circuit board or another larger device. The adhesive layer is selectively disposed on the light sources, but not the remainder of the larger device. The whole of the larger device can be placed in the fluidizing device. The fluidized luminescent material will adhere selectively to the adhesive layer on the light source, leaving the remainder of the larger device uncoated. Examples in which the light source can be part of a printed circuit board containing other integrated circuit chips include the Chipled Product Platform, e.g., Agilent Part Number HSMR-C191; Godzilla Product Platform, e.g., Agilent Part Number HSMA-C540-F0001; Artic Godzilla, e.g., Agilent Part Number HSMU-C430-QT001; and leadframes with wire bonds, e.g., Polyled Agilent Part Number HLMP 6300.

The above-described method for making a light source having a defined output spectrum provides an exemplary method. The method illustrates one possible approach for making a light source having a defined spectral output. Moreover, various improvements and modifications to the invention may occur to those skilled in the art, and those improvements and modifications will fall within the scope of this invention as set forth in the claims below.

The present invention may be embodied in other specific forms without departing from its essential characteristics. The described embodiments are to be considered in all respects only as illustrative and not restrictive.

We claim:

1. A method for coating a light source, the method comprising:
applying liquid adhesive to the light source to form an adhesive layer;
fluidizing luminescent material; and
immersing at least a portion of the adhesive layer in the fluidized luminescent material.

2. The method of claim 1, wherein the liquid adhesive is a liquid adhesive selected from the group consisting of epoxy-anhydride, epoxy-amine, transparent polyesters, crosslinkable polyurethanes, and ultraviolet (UV) curable epoxy resins.

3. The method of claim 1, wherein the liquid adhesive includes a surfactant.

4. The method of claim 1, further comprising heating the liquid adhesive.

5. The method of claim 1, further comprising heating the light source.

6. The method of claim 1, wherein applying liquid adhesive to the light source is performed by a technique selected from the group consisting of spraying, rolling, dipping, and printing.

7. The method of claim 1, wherein applying the liquid adhesive to the light source comprises spraying the liquid adhesive onto the light source utilizing a spraying device.

8. The method of claim 7, wherein the spraying device is selected from the group consisting of a thermal inkjet printer, a piezoelectric inkjet printer, a time pressure dispensing system, an industrial spraying machine, an ink spray marking machine, and a continuous ink jet technology machine.

9. The method of claim 7, further comprising monitoring viscosity of the liquid adhesive.

10. The method of claim 1, wherein the light source is selected from the group consisting of visible light emitting diodes, visible laser diodes, ultraviolet light emitting diodes, and ultraviolet laser diodes.

11. The method of claim 1, wherein the luminescent material is disposed within the adhesive layer.

12. The method of claim 1, wherein the luminescent material is disposed upon the adhesive layer.

13. The method of claim 1, wherein the luminescent material comprises:
a phosphor compound; and
a fluidization enhancement substance.

14. The method of claim 13, wherein the fluidization enhancement substance is a thixotropic agent.

15. The method of claim 13, wherein the fluidization enhancement substance is fumed silica.

16. The method of claim 1, further comprising heating the adhesive layer.

17. The method of claim 1, further comprising drying the adhesive layer before immersing at least a portion of the adhesive layer in the fluidized luminescent material.

18. The method of claim 1, further comprising maintaining the adhesive layer in a wet state when immersing at least a portion of the adhesive layer in the fluidized luminescent material.

19. The method of claim 1, further comprising curing the adhesive layer.

20. The method of claim 19, wherein curing the adhesive layer is performed by a technique selected from the group consisting of conventional heat curing, ultraviolet curing, and microwave curing.

21. The method of claim 1, further comprising verifying light output of the light source.

22. A method for making a lighting device, the method comprising:
providing a light emitting device;
spraying liquid adhesive on the light emitting device to form an adhesive layer;
fluidizing a mixture of a phosphor compound and fumed silica; and
immersing at least a portion of the adhesive layer in the fluidized mixture of the phosphor compound and the fumed silica.

23. The method of claim 22, wherein the light emitting device is disposed in a reflector cup.

24. An apparatus for coating a light source, the apparatus comprising:
means for applying liquid adhesive to the light source to form an adhesive layer; and
means for fluidizing luminescent material, the luminescent material fluidizing means adapted to receive at least a portion of the adhesive layer.

25. The apparatus of claim 24, further comprising means for curing the adhesive layer.
